(19) United States
(12) Patent Application Publication
(10) Pub. No.: US 2005/0276032 A1
(43) Pub. Date: Dec. 15, 2005

(54) Lamp

(76) Inventor: Chun-I Chen, Taichung (TW)

Correspondence Address: Wisam Enterprises Co., Ltd., P.O. Box No. 6-57, Junghe, Taipei, 235, TW

(21) Appl. No.: 10/852,233

(22) Filed: May 25, 2004

(51) Int. Cl. F21V 9/16

(52) U.S. Cl. 362/84

(57) ABSTRACT

The present invention discloses a lamp having a lamp stand, a lamp holder, an electric light and a lampshade, with at least one luminescent pattern set on the lamp stand or the lampshade. An electric wire of the luminescent patterns is connected to the circuit of the electric light. The luminescent patterns can be turned on/off through a switch of the electric light, providing extra artistic and delightful effects to the lamp.

### BACKGROUND OF THE INVENTION

(a) Field of the Invention

This invention relates to a lamp and, more specifically, to a lamp, such as table lamp, standard lamp, pendant, wall lamp or downlight, with at least one luminescent pattern set on the lamp stand or the lampshade. An electric wire of the luminescent patterns is connected to a power supply control circuit of an electric light either in parallel or in series. The electric light and the luminescent patterns can be turned on/off through a switch to enhance the artistic and delightful effect to the lamp.

(b) Description of the Prior Art

Heretofore, it is known to construct a lamp, such as table lamp, standard lamp, pendant, wall lamp or downlight, installed with a switch to turn on/off the electric light (bulb or fluorescent tubes), adjust the light intensity, or turn on different number of electric lights. A lamp of such construction is typically lack of artistic and delightful feature and there is a space for improvement.

The present invention improves on the heretofore known lamp by providing a luminescent component. This innovative feature is expected to meet the market demand on the variety of lamp products.

### SUMMARY OF THE INVENTION

It is therefore a primary object of the present invention to provide a lamp, with at least one luminescent pattern set on the lamp stand (including a supporting rod) or the lampshade. The luminescent patterns can be turned on/off through the switch of the electric light, enhancing the artistic and delightful effects to the lamp.

Another object of the present invention is to provide a lamp wherein the wires of the luminescent patterns are connected to the power supply control circuit of the electric light either in parallel or in series.

A further object of the present invention is to provide a lamp with a switch to change between different luminescent patterns. By changing the switch mode, either manually or automatically, users choose between different modes of lighting and flashing of the luminescent patterns. At least one luminescent pattern is installed on the lamp stand or the lampshade. The electric wire of the luminescent patterns is connected to the power supply control circuit of the electric light so that the switch of the lamp is used for controlling the on/off of both the electric light and the luminescent patterns.

The electric light (bulb or tube) of the present invention can be turned on/off with the switch. The luminescent patterns on the lamp stand or the lampshade can also be turned on/off/flashing with the same switch in fixed or random order. This inventive feature gives artistic and delightful effect to the lamp.

### BRIEF DESCRIPTION OF THE DRAWINGS

An embodiment of the invention will now be described by way of example only, with reference to the accompanying drawing, in which:

FIG. 1 is a perspective view of a lamp according to the present invention.

FIG. 2 is an explosive view of a lamp in accordance with the present invention shown in FIG. 1.

FIG. 3 is a schematic drawing showing the connection of the luminescent patterns in an embodiment of the present invention.

FIG. 4 is a perspective view of another embodiment of the present invention.

FIG. 5 is a perspective view of a further embodiment of the present invention.

### DESCRIPTION OF THE PREFERRED EMBODIMENT

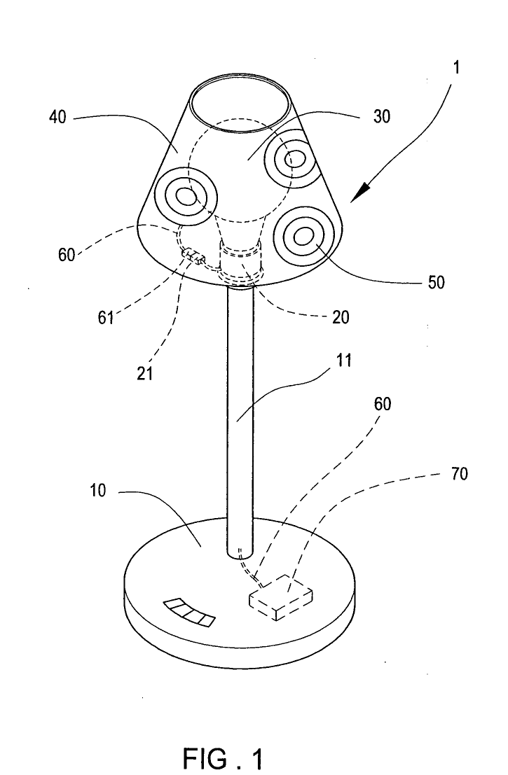

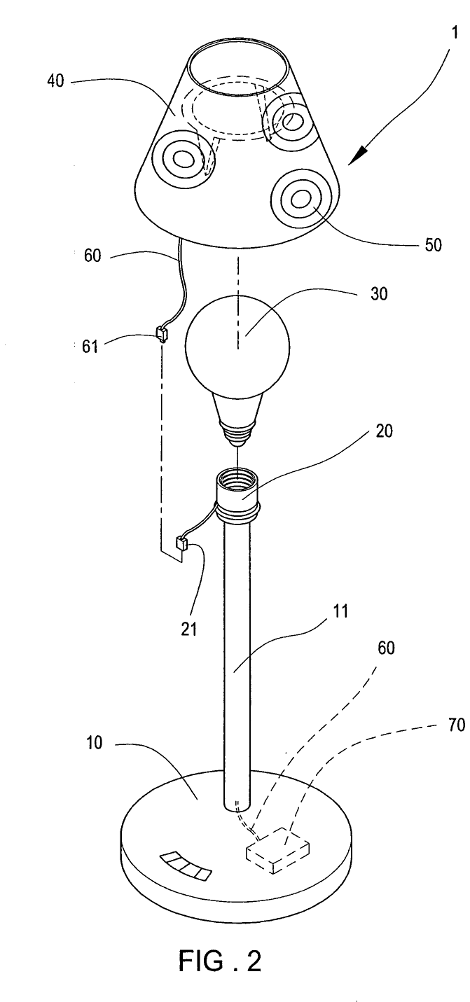

Referring to FIG. 1 and FIG. 2, a lamp 1 of the present invention is composed of a lamp stand 10, a lamp holder 20, an electric light 30 and a lampshade 40. At least one luminescent pattern 50 is set on the lamp stand 10 or the lampshade 40. An electric wire 60 of the luminescent patterns 50 is connected to a power supply control circuit 70 of the electric light 30.

As is apparent in FIG. 1 and FIG. 2, a supporting rod 11 extending upwards is set on the lamp stand 10 of the lamp 1 and a lamp holder 20 is installed on top side of the supporting rod 11 for accommodating the electric light 30. On the top of the lamp 1 is the lampshade 40. The power supply control circuit 70 is installed inside the lamp stand 10. As mentioned above, the luminescent patterns 50 are set on the lampshade 4, and the electric wire 60 (in the form of printed circuit, flexible printed circuit, flat cable or general wire) of the luminescent patterns 50 extends from the inner surface of the lampshade 40. At the end of the wire 60 is a connector 61, which is connected to a connector 21 of the lamp holder 20 so as to make the electric wire 60 connect with the power supply control circuit 70 for controlling the luminescent pattern 50.

The electric light 30 of the lamp 1 can be turned on/off by switching the power supply control circuit 70. The luminescent patterns 50 on the lampshade 40 can also be turned on/off/flashing with the power supply control circuit 70.

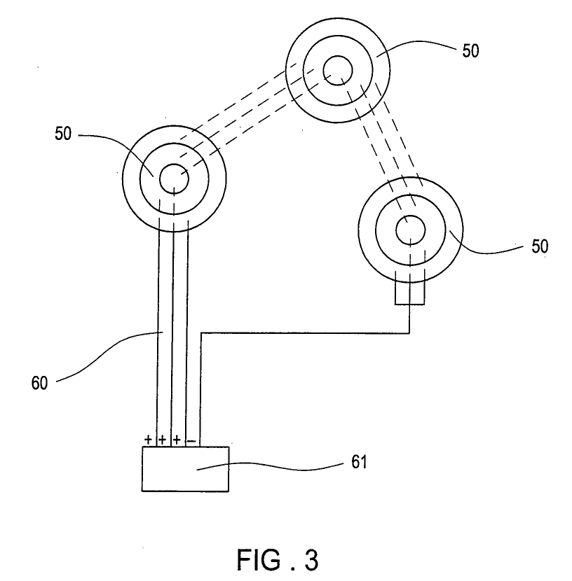

The luminescent patterns 50 may have a number of identical or different figures in different colors. The luminescent patterns 50 are connected with each other either in a series circuit or in a parallel circuit. As can be seen in FIG. 3, each luminescent pattern 50 includes three concentric circles, which are controlled by a parallel circuit while different luminescent patterns 50 are connected to each other with a series circuit. Further, the power supply control circuit 70 of the electric light 30 consists of a set of inverter or an integrated circuit that enables multiple-section switches between on/off/flashing modes in a fixed or random order.

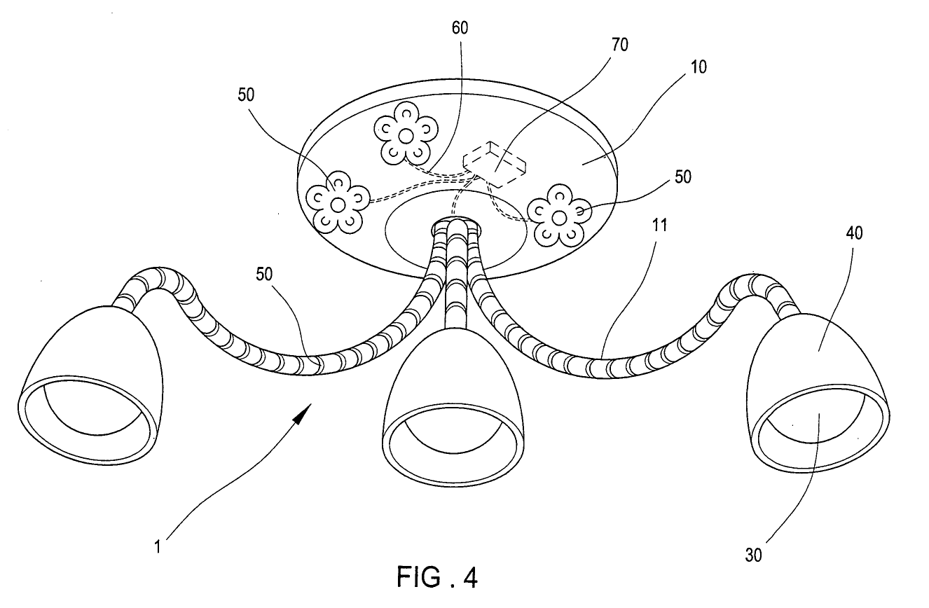

Another embodiment of the present invention is shown in FIG. 4, with the luminescent patterns 50 set on the lamp stand 10 or the supporting rod 11. The electric wire 60 of the luminescent patterns 50 is inside the lamp stand 10 as well as the supporting rod 11 and directly connected to the power supply control circuit 70 of the electric light, providing extra artistic and delightful effect.

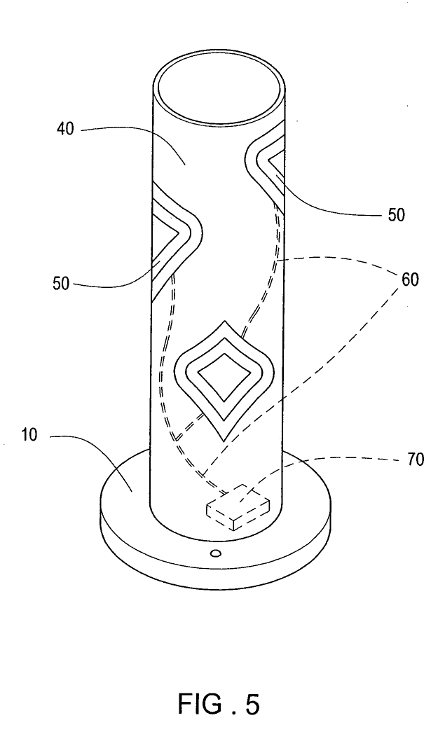

Refer to FIG. 5, an embodiment of the present invention includes a lamp stand 10, a lampshade 40 and luminescent patterns 50. By the connection between the electric wire 60 inside the lamp stand 10 and the power supply control circuit 70, the luminescent pattern 50 is turn on/off. This embodiment can be used as decorative light or night light.

While a preferred embodiment of the invention has been shown and described in detail, it will be readily understood and appreciated that numerous omissions, changes and additions may be made without departing from the spirit and scope of the invention.

1. A lamp comprising:
a lamp stand, a lamp holder, an electric light and a lampshade, wherein the lamp is characterized in that at least one luminescent pattern is set on the lampshade, an electric wire extending from the luminescent patterns is connected to a power supply control circuit of the electric light.

2. A lamp comprising:
a lamp stand, a lamp holder, an electric light and a lampshade, wherein the lamp is characterized in that at least one luminescent pattern is set on the lamp stand, an electric wire extending from the luminescent patterns is connected to a power supply control circuit of the electric light.

3. A lamp as claimed in claim 1, wherein the luminescent patterns are connected with each other in series.

4. A lamp as claimed in claim 2, wherein the luminescent patterns are connected with each other in series.

5. A lamp as claimed in claim 1, wherein the luminescent patterns are connected with each other in parallel.

6. A lamp as claimed in claim 2, wherein the luminescent patterns are connected with each other in parallel.

7. A lamp as claimed in claim 1, wherein the power supply control circuit of the electric light further having a set of inverter.

8. A lamp as claimed in claim 2, wherein the power supply control circuit of the electric light further having a set of inverter.

9. A lamp as claimed in claim 1, wherein the power supply control circuit of the electric light further having an integrated circuit.

10. A lamp as claimed in claim 2, wherein the power supply control circuit of the electric light further having an integrated circuit.

11. A lamp as claimed in claim 1, wherein a connector is arranged on one end of the electric wire, which is connected to another connector arranged on the lamp holder so as to make the electric wire connect with the power supply control circuit for controlling the luminescent patterns.

12. A lamp as claimed in claim 1, wherein the lamp having a lamp stand, a lampshade and at least one luminescent pattern; the luminescent pattern is connected with the power supply control circuit inside the lamp stand.
